(19) United States
(12) Patent Application Publication
(10) Pub. No.: US 2026/0101324 A1
(43) Pub. Date: Apr. 9, 2026

(54) UNIFIED JOINT SOUNDING PROCEDURE FOR COORDINATED BEAMFORMING

(71) Applicant: QUALCOMM Incorporated, San Diego, CA (US)

(72) Inventors: Bin TIAN, San Diego, CA (US); Sameer VERMANI, San Diego, CA (US); Jialing Li CHEN, San Diego, CA (US)

(21) Appl. No.: 18/909,813

(22) Filed: Oct. 8, 2024

(51) Int. Cl. H04W 72/044; H04L 25/02

(52) U.S. Cl. CPC H04W 72/046; H04L 25/0224

(57) ABSTRACT

Certain aspects of the present disclosure provides a method for wireless communication utilizing coordinated beamforming (CoBF). According to certain aspects, an apparatus (e.g., a non-AP STA) obtain a joint packet output simultaneously from a first wireless node and a second wireless node, wherein the first wireless node is associated with a first basic service set (BSS) and the apparatus and second wireless node are associated with a second BSS and the joint packet has a training field with one or more first spatial streams from the first wireless node and one or more second spatial streams from the second wireless node; generates channel feedback, based on the first spatial streams, for a first channel between the first wireless node and the apparatus; and provides the channel feedback to at least one of the first wireless node or the second wireless node.

### TECHNICAL FIELD

This disclosure relates generally to wireless communication, and more specifically, to coordinated beamforming (CoBF).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication at a third wireless node. The method includes obtaining a joint packet output simultaneously from a first wireless node and a second wireless node, wherein the first wireless node is associated with a first basic service set (BSS) and the third wireless node and second wireless node are associated with a second BSS and the joint packet has at least one training field with one or more first spatial streams from the first wireless node and one or more second spatial streams from the second wireless node; generating channel feedback, based on the first spatial streams, for a first channel between the first wireless node and the third wireless node; and providing the channel feedback to at least one of the first wireless node or the second wireless node.

Another innovative aspect of the subject matter described in this disclosure can be implemented in a method for wireless communication at a first wireless node. The method includes outputting a joint packet in coordination with a second wireless node, wherein the first wireless node is associated with a first basic service set (BSS) and the second wireless node and a third wireless node are associated with a second BSS and the joint packet has at least one training field with one or more first spatial streams from the first wireless node and one or more second spatial streams from the second wireless node and obtaining channel feedback, after outputting the joint packet, for a first channel between the first wireless node and the third wireless node.

Another innovative aspect of the subject matter described in this disclosure can be implemented in a method for wireless communication at a third wireless node. The method includes obtaining first and second packets sequentially from a first wireless node and a second wireless node, respectively, wherein the first wireless node is associated with a first basic service set (BSS) and the third wireless node and second wireless node are associated with a second BSS; generating and provide channel feedback, based on the first packet, for a first channel between the first wireless node and the third wireless node as part of a first sounding procedure; and generating and provide channel feedback, based on the second packet, for a second channel between the second wireless node and the third wireless node as part of a second sounding procedure, wherein the first sounding procedure and second sounding procedure occur at different rates.

Another innovative aspect of the subject matter described in this disclosure can be implemented in a method for wireless communication at a first wireless node. The method includes outputting a first packet as part of a first channel sounding procedure involving the first wireless node and a third wireless node, wherein the first wireless node is associated with a first basic service set (BSS) and the first wireless node is associated with a second BSS; obtaining channel feedback, after outputting the first packet, for a first channel between the first wireless node and the third wireless node; outputting a second packet as part of a second channel sounding procedure involving the first wireless node and a second wireless node, wherein the second wireless is associated with the first BSS; and obtaining channel feedback, after outputting the second packet, for a second channel between the first wireless node and the second wireless node.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIGS. 4 and 5 show pictorial diagrams of example wireless communication networks, in which coordinated beamforming (CoBF) may be utilized.

FIGS. 6A, 6B, and 7 show example timing diagrams for channel state information (CSI) feedback for CoBF.

FIG. 8 shows an example diagram of sounding and CSI feedback for CoBF, in accordance with aspects of the present disclosure.

FIG. 9 shows an example timing diagram for a joint sounding procedure, in accordance with aspects of the present disclosure.

FIGS. 10 and 11 show example timing diagrams for sounding procedures that occur at different rates, in accordance with aspects of the present disclosure.

FIGS. 12, 13, 14, and 15 show flowcharts illustrating example processes performable by or at a wireless node, in accordance with aspects of the present disclosure.

FIG. 16 shows a block diagram of an example wireless communication device

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In order to address the issue of increasing bandwidth requirements that are demanded for wireless communication systems, different schemes are being developed to allow multiple user terminals to communicate with a single access point (AP) or multiple APs by sharing the channel resources while achieving high data throughputs. Multiple Input Multiple Output (MIMO) technology represents one such approach that has recently emerged as a popular technique for the next generation communication systems.

A MIMO system employs multiple (N_{T}) transmit antennas and multiple (NR) receive antennas for data transmission. A MIMO channel formed by the N_{T} transmit and N_{R} receive antennas may be decomposed into NS independent channels, which are also referred to as spatial channels, where N_{S}≤min{N_{T}, N_{R}}. Each of the NS independent channels corresponds to a dimension. The MIMO system can provide improved performance (such as higher throughput and greater reliability) if the additional dimensionalities created by the multiple transmit and receive antennas are utilized.

In wireless networks with multiple APs and multiple user stations (STAs), concurrent transmissions may occur on multiple channels toward different STAs, both in uplink and downlink directions. Many challenges are present in such systems. For example, the AP may transmit signals using different standards. A receiver STA may be able to detect a transmission mode of the signal based on information included in a preamble of the transmission packet.

A downlink multi-user MIMO (MU-MIMO) system based on Spatial Division Multiple Access (SDMA) transmission can simultaneously serve a plurality of spatially separated STAs by applying beamforming at the AP's antenna array. Complex transmit precoding weights can be calculated by the AP based on channel state information (CSI) received from each of the supported STAs.

In a distributed MU-MIMO system, multiple APs may simultaneously serve a plurality of spatially separated STAs by coordinating beamforming by the antennas of the multiple APs. For example, in systems utilizing such coordinated beamforming (CoBF), multiple APs may coordinate transmissions to each STA in an effort to mitigate interference to each other's STAs.

In CoBF, an AP of one basic service set (BSS) may obtain channel state information (CSI) from non-AP STAs of an overlapping BSS (OBSS) in order to mitigate interference (e.g., by forming nulls) to the STA(s). This may involve cross-BSS sounding and CSI feedback from non-AP STA(s) to OBSS AP(s). Each AP may also obtain CSI from its own BSS non-AP STA(s) for forming beams to the STA(s).

Various kinds of sounding protocols may be used to obtain CSI from non-AP STAs. A first kind of sounding protocol may be referred to as a joint sounding protocol, in which first and second APs (in-BSS and OBSS) coordinate to send a joint packet, such as a null data packet (NDP). From a non-AP STA's perspective, the joint packet appears as a single packet-because common information is simultaneously transmitted from each AP. To allow measurement of a first channel between the non-AP STA and the in-BSS AP and a second channel between the non-AP STA and the OBSS AP, the joint packet may include a training field that has different streams transmitted by the different APs. For example, the non-AP STA may estimate the first channel based on first streams transmitted by the in-BSS AP and may estimate the second channel based on second streams transmitted by the OBSS AP.

A second kind of sounding protocol may be referred to as a sequential sounding protocol, in which the In-BSS and OBSS APs send sequential packets. The non-AP STA may estimate the first channel based on the sequential packet transmitted by the in-BSS AP and may estimate the second channel based on the sequential packet transmitted by the OBSS AP.

Having such different kinds of sounding procedure may help accommodate different types of devices with different capabilities. For example, a non-AP STA may need to support a greater number of spatial streams (SSs) in order to process joint sounding procedure. For example, a device that only supports 4ss reception in a sounding NDP, may not be able to participate in a joint sounding procedure if each (In-BSS and OBSS) AP (with 4 antennas) transmits a joint NDP with 4 spatial streams each (or 8 ss total). The same device, however, may be able to participate in sequential sounding with the same APs, needing to process only 4ss NDPs.

Unfortunately, sequential sounding may not be sufficient, for certain scenarios such as partial rank-nulling scenarios. Partial nulling generally refers to nulling of a subset of Eigen modes of an OBSS STA. A partial nulling scenario may be particularly important for COBF for dimensionality and performance reasons. Thus, joint-NDP based sounding procedures may be important in such scenarios.

Aspects of the present disclosure provide mechanisms for effectively unifying joint and sequential sounding procedures (into what may be considered a single sequence). Such unification may help reduce hardware cost, for example, at the AP to support a single sounding sequence, while still provided the benefits of joint sounding. As will be described in greater detail below, the mechanisms proposed herein may allow more advanced STAs (e.g., 8ss-capable STAs) to benefit from joint sounding while still including less advanced (e.g., 4ss-capable STAs) in COBF, with relatively minor or no performance loss.

Particular aspects of the subject matter described in this disclosure can be implemented to realize one or more of the following potential advantages. In some examples, CSI feedback and corresponding processing proposed herein may help enhance CoBF, which may help improve interference mitigation, spectral efficiency, and overall system network performance.

### Example Wireless Communication Network

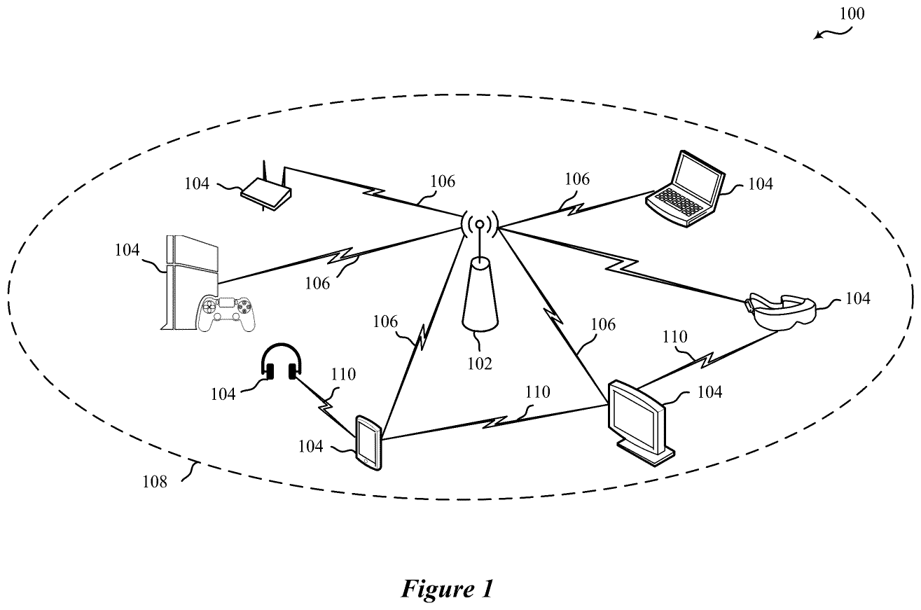

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHZ), FR4a or FR4-1 (52.6 GHz-71 GHZ), FR4 (52.6 GHz-114.25 GHZ), and FR5 (114.25 GHz-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

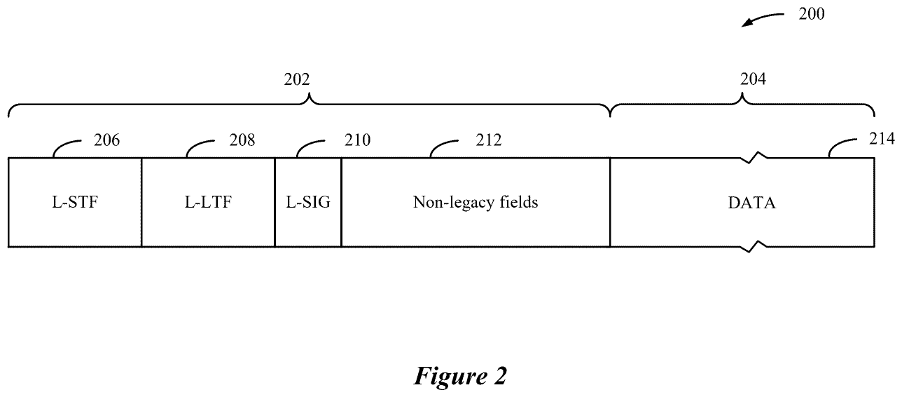

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

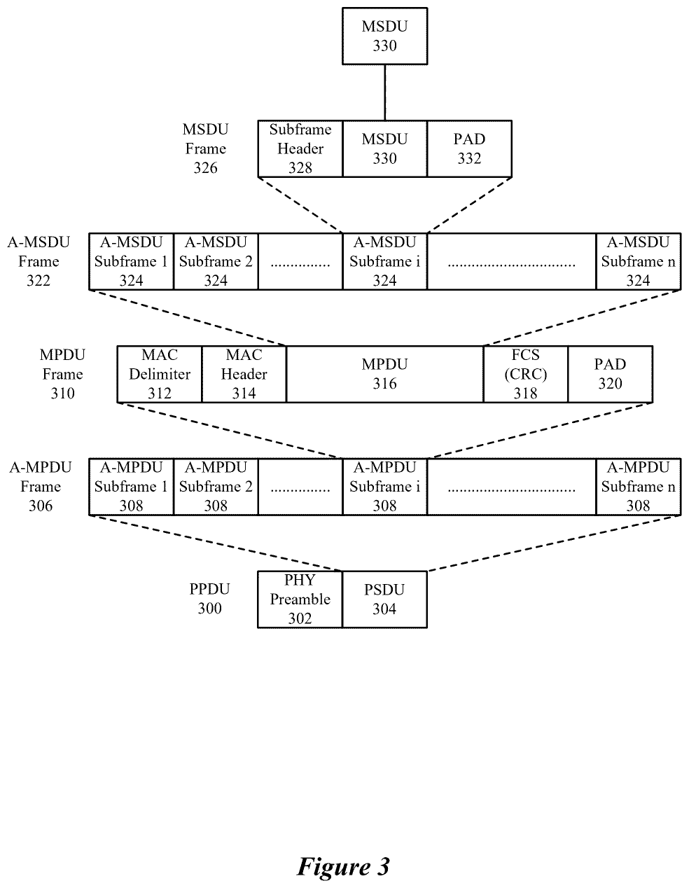

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Example Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimension within the BSS. In other words, the un-used spatial dimensions may allow for concurrent OBSS transmissions in DL.

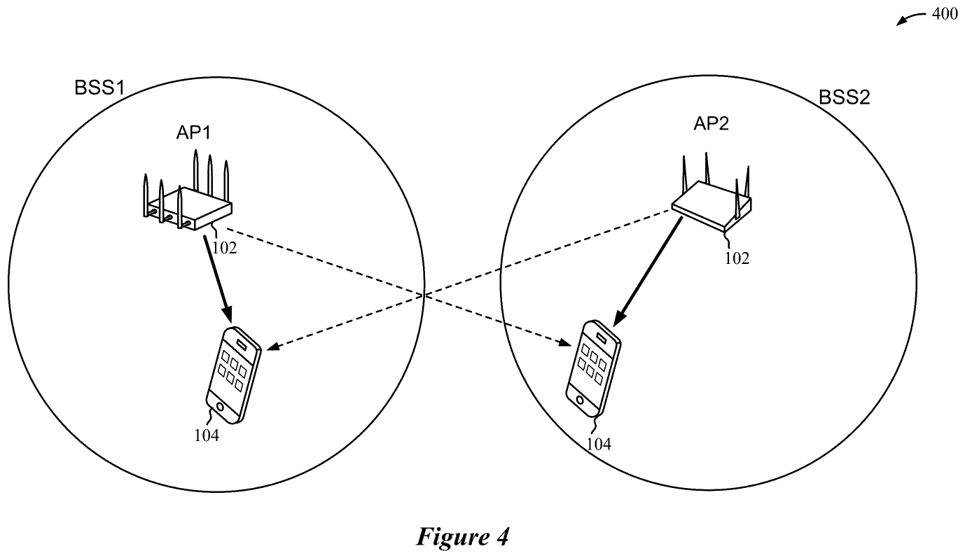

FIG. 4 illustrates a communication system 400 using coordinated DL MU-MIMO, in accordance with certain aspects of the present disclosure. As illustrated, the signal from each AP 102 is transmitted to only stations within their respective BSSs, as shown by the solid lines representing data transmissions from the AP the STAs 104 that are associated with the AP. The data transmissions from the APs cause interference to the other OBSS stations, as illustrated by the dotted lines. Un-used dimensions at the AP may be used to get rid of (e.g., null out) interference from OBSS APs.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

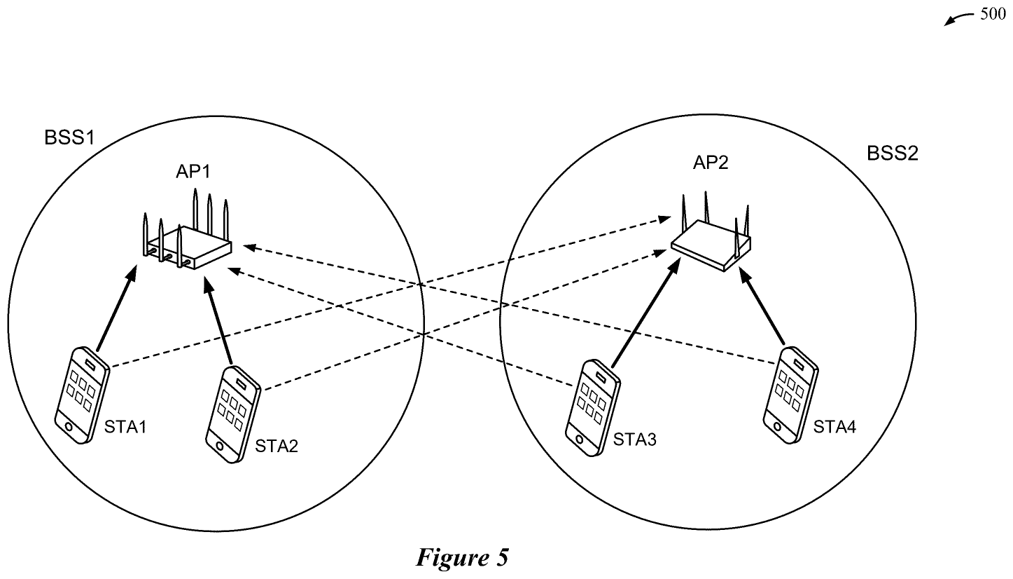

FIG. 5 illustrates an example system 500 that may utilize coordinated UL MU-MIMO. As illustrated, the signal from each STA 104 may be transmitted to only one AP 102 within their respective BSSs, as shown by the solid lines representing data transmissions to the AP the STAs are associated with. The data transmissions from the STAs cause interference to the other OBSS APs, as illustrated by the dotted lines. Un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to own (BSS) STAs.

### Example Coordinated Beamforming

As previously described, in CoBF, multiple APs may coordinate to suppress OBSS interference in the spatial domain. As such, CoBF typically provides gains in an opportunistic manner, for example, when in-BSS transmissions are not fully utilizing that BSS AP's spatial dimensions.

There are various types of CoBF, such as symmetric CoBF with synchronized or asynchronized transmission and asymmetric CoBF with synchronized or asynchronized transmission. With symmetric CoBF, all APs may participate in coordinated beamforming and to suppress their obsess interference to other victim STAs within other BSSs. With asymmetric CoBF, one device (or set of devices) may have higher or lower priority than other devices and/or may lack the capability to suppress OBSS interference.

In general, there can be multiple APs participating in CoBF. To facilitate understanding, however, example techniques will be described herein with reference to a CoBF scenario involving 2 APs. The techniques described herein may be extended to systems involving any number of APs.

The techniques described herein involve various processing for sounding and CSI feedback in CoBF. The techniques described herein may be applied to symmetric CoBF and asymmetric CoBF. As described above, in CoBF, an AP may obtain CSI from OBSS non-AP STA(s) to form nulls to the STA(s). This may involve cross BSS sounding and CSI feedback from non-AP STA(s) to OBSS AP(s). Each AP may also obtain CSI from its own serving non-AP STA(s) to form beams to those STA(s)

In asymmetric CoBF, sounding may involve transmission of just one packet, such as a null data packet (NDP), from a secondary AP to primary recipient. In symmetric CoBF, each AP may send out an NDP to sound the intended and interfering channels. In this context, sounding generally refers to a mechanism used to gather information about the characteristics of a communication channel, in order to optimize transmission parameters to improve the overall performance of CoBF. Sounding typically involves sending specific probe frames or signals and then analyzing the responses that provide CSI feedback, to understand the channel behavior.

There are various options for sounding, for example, involving sending out NDPs to solicit CSI feedback for intended and interfering channels. In this context, an intended channel may refer to a channel between an AP and a non-AP STA served by that AP (in a same BSS), while an interfering channel may refer to a channel between an OBSS AP and a non-AP STA.

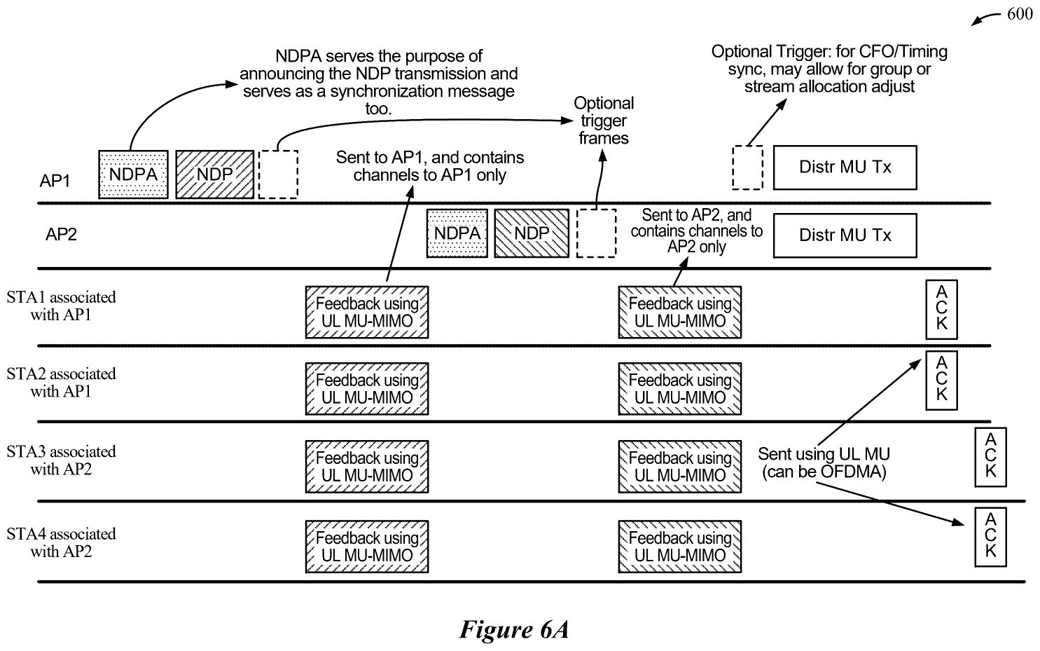

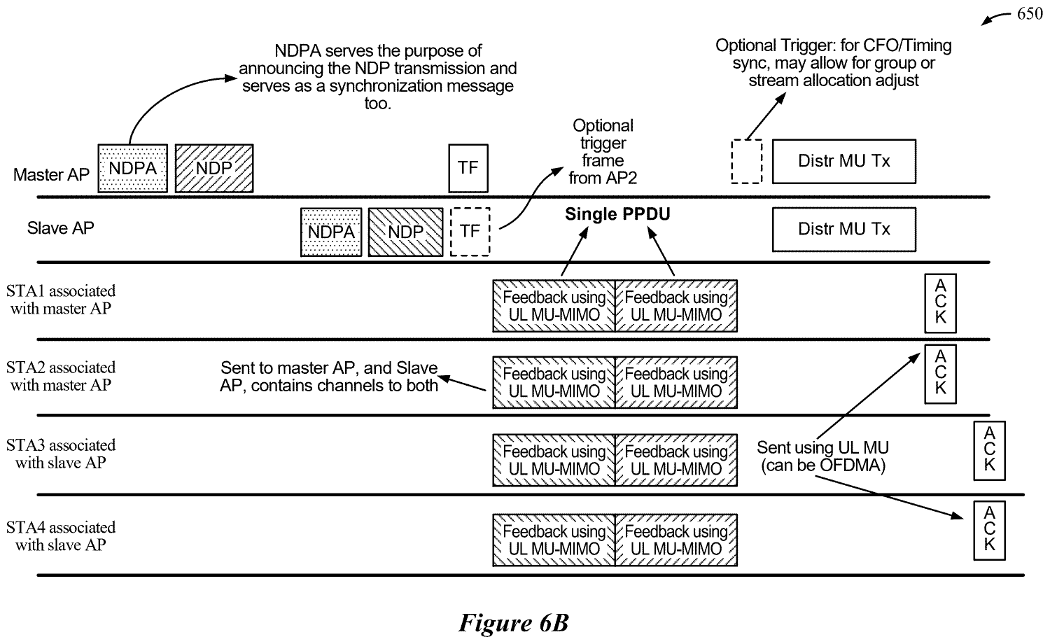

According to a first option, as illustrated in diagram 600 of FIG. 6A, each AP sends one NDP to intended and victim STAs, in a sequential manner.

In such cases, the BSS color of the AP may be included in the NDP so each STAs knows from which AP the NDP (and estimated channel) comes from. In the illustrated example, two APs (e.g., AP1 and AP2 of FIG. 5) send sequential NDPs. Based on the NDP sent from the j-th AP, each STA (the i-th STA) estimates the channel, Hᵢⱼ, channel matrix from j-th AP to the i-th STA.

As illustrated in diagram 650 of FIG. 6B, in some cases, non-AP STAs may not send CSI feedback until after all NDPs are sent and all channels are estimated.

In the illustrated example, AP1 send an NDPA and NDP, then AP2 sends an NDPA and NDP. AP1 sends a Trigger frame (TF) and at the same time AP2 may send an optional TF, triggering the STAs to send CSI feedback to both APs. To generate the CSI feedback, the non-AP STAs could use the enhanced CSI processing and small V feedback techniques described herein. The non-AP STAs could also use the large V feedback of the composite channels, provided the phase and automatic gain control (AGC) at each non-AP STAs use the same phase and AGC setting when processing all of NDP packets.

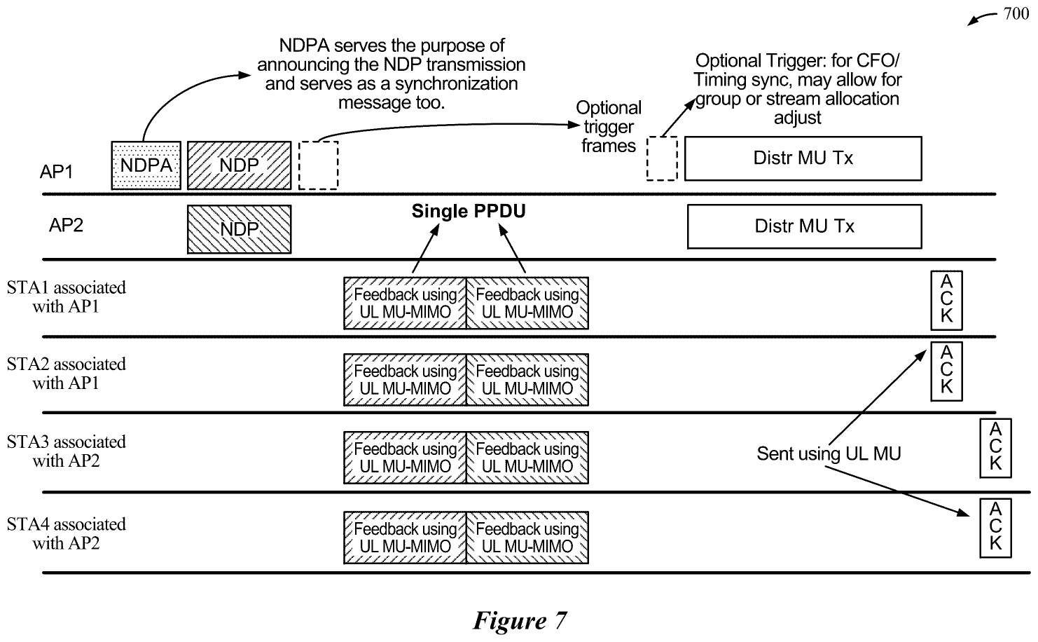

According to a second option, as illustrated in diagram 700 of FIG. 7, APs participating in CoBF collaboratively send out a joint NDP to all serving STAs. The NDP may be considered a joint NDP, even though it is sent from two different APs.

In this context, a joint NDP may be one PPDU sent from both APs, with identical information (transmitted by each AP) in all fields except in a long training field (e.g., a UHR-LTF) field. In the LTF, each AP may send different streams and the streams sent from different APs may use mutually different indices. In this manner, all APs may share a joint LTF, where the first subset of streams are sent from 1st AP, and second subset of streams are sent from a 2nd AP, so that the estimated channel is a composite channel where first subset of streams are from 1st AP and second subset of streams are from 2nd AP.

The joint NDP may use a group BSS color for the group of CoBF APs. The group BSS color may be sent in a prior packet, such as an NDP announcement (NDPA) frame from one of the APs (e.g., a sharing AP), before the joint NDP.

According to certain aspects of the present disclosure, to aid in CSI processing by a non-AP STA, a joint NDP may indicate which part of composite channel comes from which AP. For example, the joint NDP (or some other signaling mechanism) may signal the numbers of Tx antennas or streams from different APs, i.e., [N_tx_1, N_tx_2, . . . ] or [N_ss_1, N_ss_2, . . . ] and the list of CoBF BSS IDs in NDPA, so that STAs know which part of composite channel comes from intended AP and which part comes from interfering AP(s). Alternatively, the joint NDP (or some other signaling mechanism) may signal the starting stream indices for different APs and the list of CoBF BSS IDs in NDPA. If the numbers of Tx antennas or streams from different APs or the start stream indices for different APs are signaled, they may be in a prior packet, e.g., NDPA, or in the joint NDP packet (e.g., in U-SIG or the common field of the UHR-SIG).

With joint sounding, each STA (the i-th STA) may estimate the composite channel matrix at from Nₐₚ APs as Hᵢ=[Hᵢ₁ Hᵢ₂ . . . H_{iN}_{ₐₚ}], where each Hij represents a channel matrix for a channel between STAi and APj. Joint NDP may have less overhead, and may help with enhanced coordinated spatial reuse (CSR) and/or joint transmission (JT) to a single or multiple STAs.

Aspects of the present disclosure also provide various options for sending CSI feedback, including cross-BSS CSI feedback. In some cases, a backhaul (e.g., a light backhaul) between APs may be used for CSI exchange. In such cases, all STAs may send CSI feedbacks to their own APs and the APs may share with each other (exchanging CSI feedback) over the backhaul. In this case, UL transmissions (of CSI-FB) to own APs may be done in parallel, for example, if using coordinated UL MU-MIMO or coordinated UL OFDMA.

In some cases, if there is no backhaul, it may be assumed that coordinated UL MU-MIMO is used. In such cases, STAs may transmit to their own APs in parallel, then the STAs may transmit to OBSS in APs in parallel. In other cases, coordinated UL MU-MIMO may not be assumed, though this may mean both APs do not receive simultaneously and, hence, may have additional latency for each STA to feedback to all the APs one at a time.

In some cases, coordinated UL MU-MIMO may involve CoBF, with un-utilized spatial dimensions of the AP used to perform receive (Rx) nulling of OBSS UL transmissions.

Aspects of the present disclosure provide various options that may be applied in both point-to-point channel CSI processing and feedback and composite channel CSI processing and feedback.

In this context, point-to-point channel feedback generally refers to the CSI feedback of a channel between two STAs, such as an AP and a non-AP STA (e.g., with a channel matrix Hᵢⱼ for APj and STAi). For point-to-point channel feedback, there are also various sub-options with different types of CSI processing (to generate the CSI feedback) and different types of content fed back (as CSI feedback).

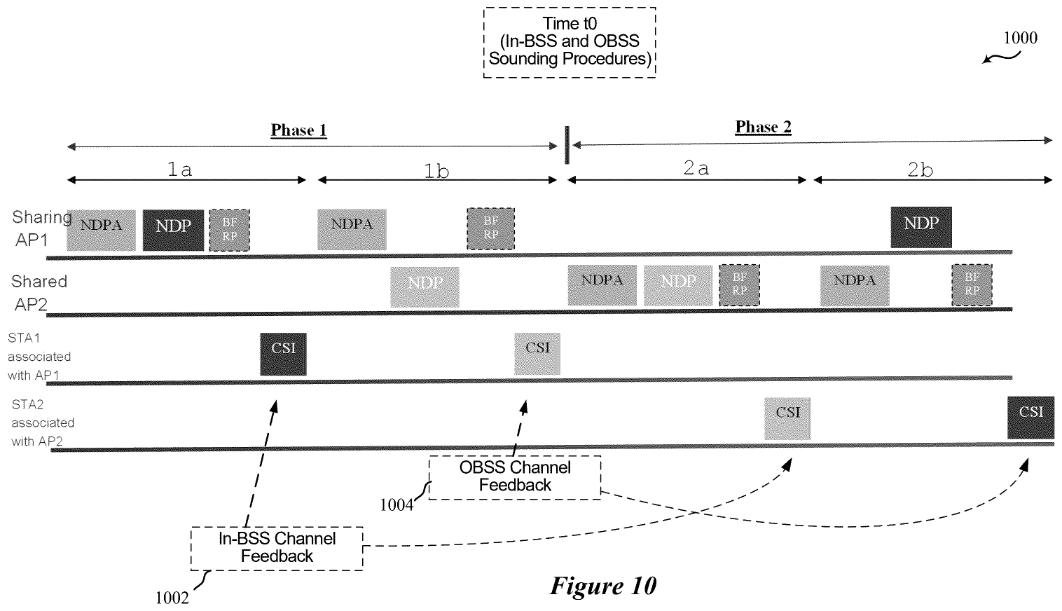

A composite channel may be either point to multi-point (e.g., from one AP to multiple non-AP STAs) or multi-point to single point (e.g., from multiple APs to a single STA). In this context, composite channel feedback generally refers to the CSI feedback of a composite channel, such as the channel from multiple APs (e.g., an in-BSS and OBSS AP) to a single STA (Hᵢ). As will be described below with reference to FIG. 10, aspects of the present disclosure provide techniques for a non-AP STA to generate composite channel CSI feedback and for an AP to reconstruct point-to-point channel CSI from the composite channel CSI feedback.

Point-to-point Channel CSI processing and feedback may be performed as follows. An N_{rx,i}×N_{tx,j} channel matrix from a j-th AP (AP) to an i-th STA (STAi) may be denoted as Hᵢⱼ where N_{rx,i} is the number of receive antennas of APj and N_{tx,j} is the number of transmit antennas from APj (and N_{rx,i}≤N_{tx,j}).

Based on the channel estimation of a packet (e.g., an NDP) from APj, STAi may obtain the channel matrix Hᵢⱼ and perform a singular value decomposition (SVD) on Hᵢⱼ to obtain:

$${H}_{ij} = {U}_{ij} \cdot {S}_{ij} \cdot {V}_{ij}^{′} ,$$

where Uᵢⱼ is an N_{rx,i}×N_{rx,i} (left semi-unitary or) unitary matrix, Sᵢⱼ is an N_{rx,i}×N_{rx,i} diagonal matrix with the singular values of the channel Hᵢⱼ, and Vᵢ is an N_{tx,j}×N_{rx,i} (right) semi-unitary (or unitary) matrix. In some cases, CSI feedback may be what is referred to as large V feedback, where STAi feeds back Uᵢⱼ, Sᵢⱼ and Vᵢⱼ.

In some cases, CSI feedback may be what is referred to as small V feedback. With small V feedback, STAi feeds back Sᵢⱼ and Vᵢⱼ of requested rank N_{fb,i}, i.e., S_{fb,ij}=Sᵢⱼ(1:N_{fb,i},1:N_{fb,i}) and V_{fb,ij}=Vᵢⱼ (:, 1:N_{fb,i}), where the requested rank may be signaled to the STA in a prior packet, e.g., NDPA. The notation of A(i:j, k:l) represents a submatrix of A, by selecting from the i-th to j-th rows and from the k-th to 1-th columns. The notation “:” in a submatrix A(:, k:l) represents a submatrix of A, by selecting all rows and from the k-th to l-th columns. Likewise, the notation “:” in a submatrix A(i:j, :) represents a submatrix of A, by selecting from the i-th to j-th rows and all columns. In this manner, an AP may request CSI feedback (of certain matrices) to be of a certain rank (or number of columns). For example, an SVD may produce 4 Eigen channels, but the AP may only request a rank of 2 or 3 in a CSI feedback request.

In the case of small V feedback, the reconstructed channel

$${rH}_{ij} = {S}_{fb , ij} \cdot {V}_{fb , ij}^{′}$$

corresponds to the Eigen channels using the

$${U}_{nfb , ij}^{′}$$

receiver (which is not lea back), where U_{nfb,ij}=Uᵢⱼ(:, 1:N_{fb,i}). In this case, the full channel Hᵢⱼ may not be reconstructed, which may result in less than optimal CoBF.

According to one of the sub-options presented herein, however, STAi may use a CSI processing technique for the small V feedback of the intended and interfering channels based on the same receiver.

One example of this first sub-option for point-to-point channel CSI processing and feedback may assume AP1 (BSS1) and AP2 (BSS2) transmit NDP(s) for sounding. In such cases, STA1 may generate, based on the NDP(s), CSI FB for intended channel (between AP1 and STA1) based on SVD of original channel and generates CSI FB for interfering channel (between AP2 and STA1) based on an SVD of equivalent channel.

In some cases, STA1 may provide this (enhanced small V) CSI-FB to AP1. In some cases, STA1 may also provide this CSI-FB directly to AP2. In other cases, AP1 and AP2 may exchange CSI-FB (e.g., if a backhaul exists). For example, AP1 may transmit the CSI-FB for the interfering channel (between AP2 and STA1) to AP2 via a light backhaul. While not shown, STA2 may also generate CSI-FB for its intended channel (between AP2 and STA2) and interfering channel (between AP1 and STA2) and provide this CSI-FB to at least its AP (AP2).

This enhanced CSI processing for small V feedback according to this first sub-option may be described as follows, assuming the i-th AP is the serving AP of the i-th STA so that Hut is an intended channel and all other Hᵢⱼ where j≠i are interfering channels.

For intended channel Hᵢᵢ, STAi may feed back S_{fb,ii}=Sᵢᵢ(1:N_{fb,i}, 1:N_{fb,i}) and V_{fb,ii}=Vᵢᵢ(:, 1:N_{fb,t}) where N_{fb,i}=N_{ss,i}, where N_{ss,i} is the number of streams for the i-th STA that the i-AP intended to send in the CoBFed transmission, assuming using the eigen receiver

$${U}_{ss , ii}^{′}$$

(not fed back) where U_{ss,ii}=Uᵢᵢ(:, 1:N_{ss,i}).

For interfering channel Hᵢⱼ where ≠i, the equivalent channel assuming the Eigen receiver at the i-th STA is

$${U}_{ss , ii}^{′}$$

so that the equivalent channel from the j-th AP to the i-th STA after this Eigne receiver processing becomes

$${U}_{ss , ii}^{′} {H}_{ij} .$$

For the CSI FB for the interfering channel, STAi may perform SVD on the equivalent channel

$${U}_{ss , ii}^{′} {H}_{ij}$$

to obtain:

$${U}_{ss , ii}^{′} {H}_{ij} = {U}_{ss , ij} \cdot {S}_{ss , ij} \cdot {V}_{ss , ij}^{′} ,$$

where U_{ss,ij} is an N_{ss,i}×N_{ss,i} unitary matrix, S_{ss,ij} is an N_{ss,i}×N_{ss,i} diagonal matrix with the singular values of the equivalent channel

$${U}_{ss , ii}^{′} {H}_{ij} ,$$

S_{ss,ij}(1:N_{fb,i}, 1:N_{fb,i}) and V_{fb,ij}=V_{ss,ij}(:, 1:N_{fb,i}) where N_{fb,i}=N_{ss,i}.

A distinction between the enhanced small V feedback according to this first sub-option and typical V feedback is that the enhanced feedback (for the interfering channels) is based on the SVD of the equivalent channel

$${U}_{ss , ii}^{′} {H}_{ij}$$

instead of the SVD of the original channel Hᵢⱼ. In this way, the same receiver

$${U}_{ss , ii}^{′}$$

is assumed for intended and interfering channels. In this example, it is assumed that the Eigen receiver

$${U}_{ss , ii}^{′}$$

is used to generate both the CSI FB for the intended channel Hᵢᵢ and the CSI FB for the interfering equivalent channel

$${U}_{ss , ii}^{′} {H}_{ij} .$$

A more general case in the enhanced feedback is to use a same linear receiver Gᵢ to generate both the CSI FB for the intended equivalent channel GᵢHᵢⱼ and the CSI FB for the interfering equivalent channel GᵢHᵢⱼ.

According to another of the sub-options presented herein, however, STAi may feedback U, S, and V from the SVD of the point-to-point channel. For example, STAi may feed back Uᵢⱼ, Sᵢⱼ and Vᵢⱼ of a requested rank N_{fb,i}, i.e., U_{nfb,ij} (fed back in this case), S_{fb,ij} and V_{fb,ij}.

In some cases, it may be beneficial to exchange certain information that may be needed for joint NDP via NDPA. In some cases, a STA information (info) field may include a special AID value for a shared AP. In some cases, a sounding dialogue token reserved state might be used to signal that this is a NDPA that signals joint sounding. Such an indication may indicate to an AP (and possibly the STAs) that a joint sounding NDP is going to arrive.

In some cases, such information may be conveyed via a single STA info field. Such a field may be considered a special STA Info Field targeted to an AP in NDPA preceding a joint NDP. In some cases, the special STAID per AP can be advertised in the beacon as some form of AP identifier (which may be a self-chosen IP, referred to as a “CoBF special APID). Collisions may be resolved in a similar manner as BSS color collisions. In some cases, the CoBF special APID may be 11 bits.

For CoBF sounding, an NDPA may still being addressed to an in-BSS STA. There may be no need for changes to a BSS ID (transmitter of the NDPA) and STAID in the STA info field to the target STA. Other information may be conveyed, such as the number of streams (columns) being requested in the feedback is Nc. In some cases, a special STA info field may be addressed to a shared AP. This field may convey the starting and ending stream index for the shared AP and may convey information regarding what rows of the P-matrix to use. The STA info field may use a special AID which is associated with the AP.

In some cases, asymmetric CoBF may be supported, for example, with two 4 Tx APs, each having one active STA. Such an example may assume a secondary BSS has a 2Rx STA and secondary AP intends to transmit 1ss to that station. The example may also assume that the primary STA is explicitly sounded to secondary AP channel and that the primary STA pre-calculates the optimum receive filter and pre-compensates the interference channel feedback to the interfering AP (e.g., to provide a single eigen mode where interference needs to be nulled).

Various potential issues related to asymmetric CoBF may be addressed. Such issues may be explained considering an example that assumes a 2Rx STA in the primary BSS. In one case, the STA may be receiving 1ss and feeds back a single Eigen mode to secondary BSS. In such cases, there may be joint LTFs, for which we need pre-negotiation of several things between secondary and primary AP. In another case, the STA may receive 2ss. In such cases, 2 Eigen modes may be fed back to the secondary BSS AP.

There are various options for CoBF group formation, in order to determine what APs will participate in CoBF). According to a first option, a sharing AP (e.g., AP1) sends a CoBF opportunity trigger to the APs, an intent to participate, and a final CoBF configuration. The trigger may contain a number of spatial multiplexing dimensions available at sharing AP, a list of APs that AP1 is inviting for CoBF (AP1 sees them as good CoBF candidates). For example, some STAs in BSS1 may get labeled via a background process as good candidates for CoBF with AP2 and AP3. A trigger may also indicate resources for transmitting an intent to participate. The intent to participate (transmitted using TB PPDU) may contain a number of spatial multiplexing dimensions (or number of antennas) available at shared AP and indicate to a responding AP (e.g., AP2 and AP3) STAs which are good candidates for CoBF with AP1. The final CoBF configuration may contain an identifier for the AP(s) in 2-AP groups as shared AP(s) for CoBF with sharing AP1.

According to another option for CoBF group formation, every AP may advertise various information in the beacon. Such information may include, for example, spatial multiplexing capability (maybe equal to the number of antennas) for CoBF and a list of good candidate neighboring APs for CoBF. In some cases, this list may get updated in the beacon based on the in-BSS background process. In some cases, there may be no explicit group formation phase. Rather group formation may begin directly with the sounding phase with one AP acting as sharing AP.

There are various options for resolving collisions of CoBF APID with STAID in the first option described above. For example, if AP2 picks a CoBF APID which matches STA1's ID, various information may be signaled in the NDPA. Such information may include, for example, that the NDP is a UHR variant of NDP and/or is a joint sounding NDP (e.g., via reserved state in sounding dialogue token). Such information may notify the STA1 and AP2 that there is a STA info field that is meant for AP2 at a fixed location (e.g., either the first or the last STA info field in the NDPA). In some cases, the STA may ignore that STA info field even if the STAID matches.

In some cases, such signaling may also be used by AP2, for example, to determine that an NDPA is a special NDPA, which prompts AP2 to send an NDP in response. The signaling may also notify AP2 that it needs to look for a special STA info field at either the beginning or the end.

### Unified Joint Sounding Procedure for CoBF

Aspects of the present disclosure provide mechanisms for effectively unifying joint and sequential sounding procedures (into what may be considered a single sequence). Such unification may help support STAs that have lower capability for sounding (e.g., a 4ss-capable STA) than other STAs (e.g., an 8ss-capable STA).

As will be described herein, STAs with lower capability for sounding may be able to perform partial channel estimation for joint NDP. For example, such a STA may generate and provide feedback for only the OBSS component of the joint-NDP streams.

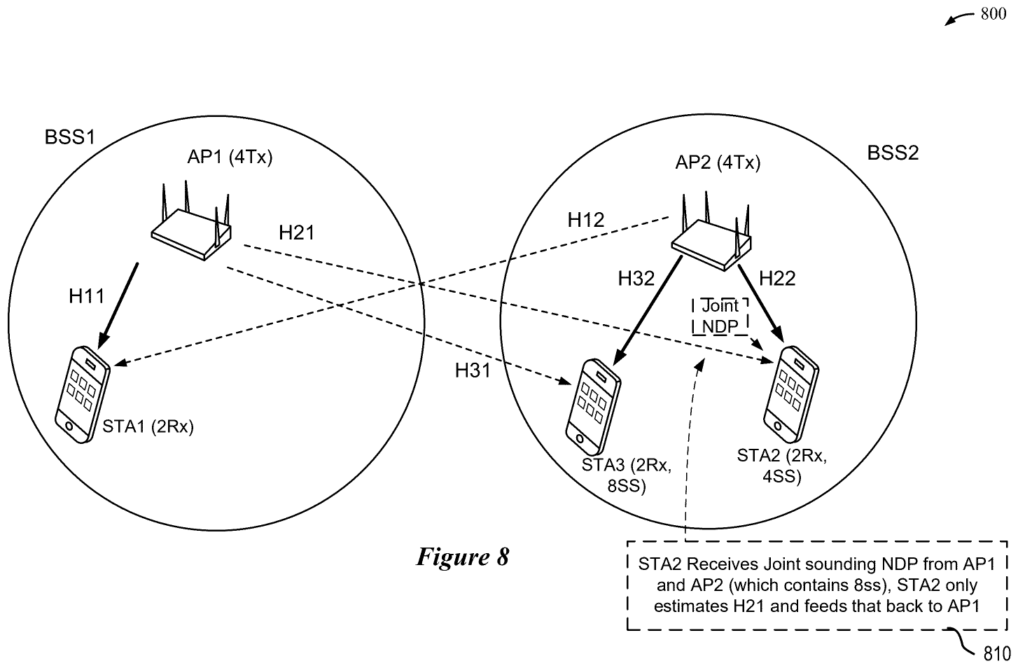

The mechanisms proposed herein may be understood with reference to diagram 800 of FIG. 8. The illustrated example assumes AP1 (associated with BSS1) and AP2 (associated with BSS2) transmit a joint NDP for sounding. The example also assumes that STA1 belongs to AP1 (part of BSS1), that STA2 and STA3 each belong to AP2, that STA3 is 8ss-capable, and STA2 is 4ss-capable. Each channel is designated based on the STA index and AP index (e.g., the OBSS channel between STA2 and AP1 is designated H21).

As noted at 810, when STA2 receives a joint sounding NDP from AP1 and AP2 which contains 8ss, STA2 only estimates the OBSS channel (H21). This is possible because this involves a 4ss channel estimation, which STA2 is capable of. STA2 may provide this feedback to AP1. In some cases, STA2 may provide the feedback directly to AP1. In other cases, STA2 may provide the feedback to AP2 which may, in turn, forward the feedback to AP1.

STA3, on the other hand, may be able to estimate both the OBSS channel (H31) and In-BSS channel (H32) and feeds them back. Accommodating both types of device (4ss-capable STA2 and 8-ss capable STA3) with a single unified procedure may help reduce hardware costs of the APs.

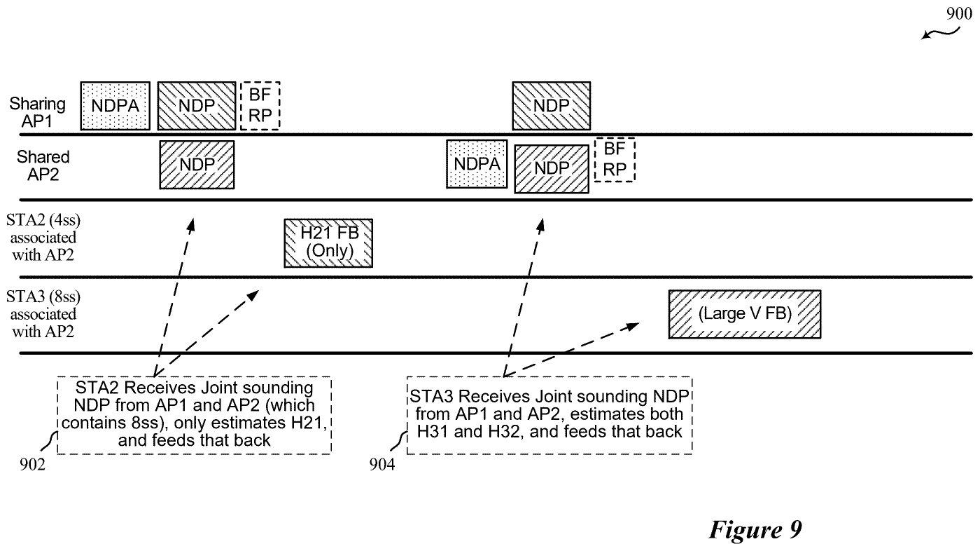

For example, as illustrated at 902 in FIG. 9, when the joint sounding procedure is performed for STA2, STA2 may generate and provide OBSS feedback (H21) only. However, as illustrated at 904, when the joint sounding procedure is performed for STA3, STA3 may generate and provide both OBSS feedback (H31) and In-BSS feedback (H32). In some cases, this feedback may be in the form of a compressed V matrix feedback (e.g., with V being the right Eigen vector matrix of SVD of the channel matrix as described above). So, columns of the V matrix correspond to H21 in the first case (of OBSS feedback only from STA2) and columns of the V matrix correspond to the SVD of the composite matrix [H31 H32] in the second case (of both OBSS and In-BSS feedback from STA3).

In this example shown in FIG. 9, STA2 does not provide In-BSS feedback (H22) to AP2. In some cases, the impact of this absence may be acceptable, as it may lead to only a slight loss in beamforming gain, with potentially no corresponding increase of interference from AP1.

In some cases, however, STA2 may still provide H22. For example, H22 may be obtained from STA2 in a separate single-BSS sounding procedure. In some cases, this In-BSS channel may not need to be updated as frequently as the OBSS channel (H21). This, the single-BSS sounding procedure may be performed less frequently than the joint sounding procedure. In some cases, the OBSS channel may need to be sounded more frequently, for example, because aging of that part (using an older, less accurate feedback) may cause increased interference to STA2. In some cases, rather than rely on In-BSS feedback, a fixed (e.g., standard-specific) or random matrix may be used.

According to certain aspects, whether or not a STA estimates and feeds back both in-BSS and OBSS components may be a function of the Nss that the STA supports for sounding. In some cases, the number of SS supported may be indicated by a parameter (e.g., Nss-for-sounding-capability). If the number of SS the STA supports for sounding is less than the total SS used by the APs participating in the joint NDP, the STA may generate and feedback only the OBSS channel.

As noted above, in such cases, the In-BSS component of the channel may be obtained through a separate sounding process. This separate sounding process for In-BSS feedback may happen at a lower frequency than the OBSS channel through joint sounding.

According to certain aspects, the O-BSS channel may be modified by the STA before being fed back. In some cases, such modification may be performed in an effort to optimize performance. For example, the modification may involve pre-multiplication by some matrices that are dependent on knowledge of the in-BSS channel.

As noted above, an AP may use a fixed or a random matrix for the in-BSS component of the channel. Whether or not an AP uses such a matrix and/or what type of matrix is used may be implementation specific or may be specified in a standard.

Certain aspects of the present disclosure may also provide enhancements to sequential sounding procedures. As noted above, it may be acceptable to obtain In-BSS sounding components less frequently. Thus, in some cases, sequential-NDP based sounding for COBF may be enhanced in an effort to optimize overhead.

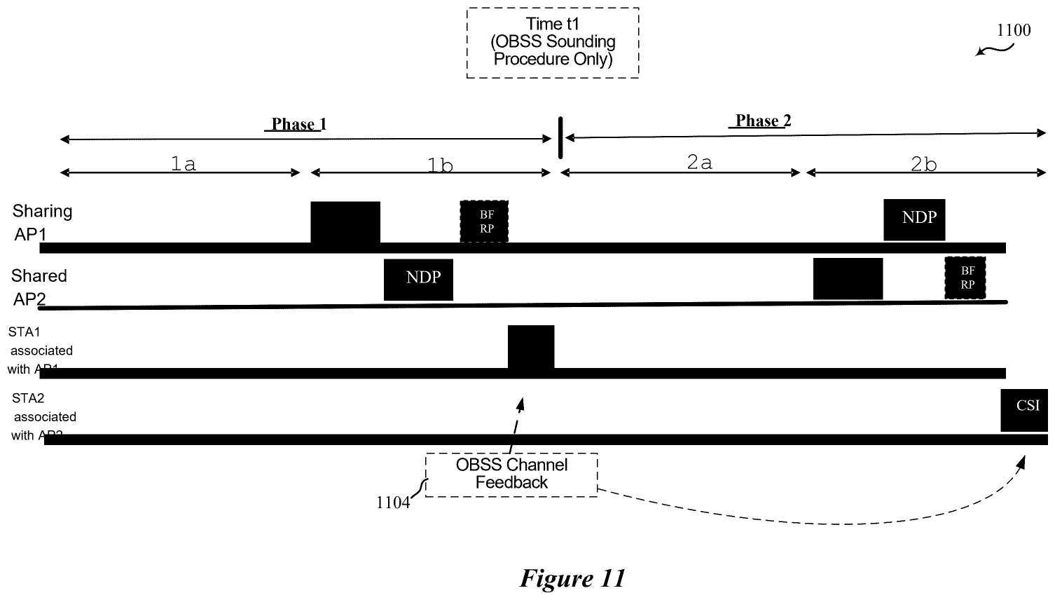

For example, as illustrated in FIG. 10 and FIG. 11, sounding procedures for OBSS and In-BSS feedback may be performed at different rates. The illustrated examples assume AP1 (associated with BSS1) and AP2 (associated with BSS2) transmit sequential NDPs for sounding. The examples also assume that STA1 belongs to (is associated with) AP1, and that STA2 belongs to AP2. The examples also assume that AP1 and AP2 have four (4Tx) antennas and that the sequential NDPs are sent with 4ss.

Referring first to diagram 1000 of FIG. 10, during a first period occurring at time 10 both In-BSS and OBSS channel feedback may be provided. As illustrated at 1002, In-BSS channel feedback may be provided by STA1 in a first sub-phase (1a) of a first phase (Phase 1), while In-BSS channel feedback may be provided by STA2 in a first sub-phase (2a) of a second phase (Phase 2). As illustrated at 1004, OBSS channel feedback may be provided by STA1 in a second sub-phase (1b) of Phase 1, while OBSS channel feedback may be provided by STA2 in a second sub-phase (2b) of Phase 2.

Referring next to diagram 1100 of FIG. 11, during a second period occurring at time t1 only OBSS channel feedback may be provided. In other words, as illustrated at 1104, this period only OBSS channel feedback may be provided by STA1 in a second sub-phase (1b) of Phase 1, while OBSS channel feedback may be provided by STA2 in a second sub-phase (2b) of Phase 2.

As illustrated by these examples, OBSS soundings (in sub-phases 1b and 2b) may happen more frequently than In-BSS sounding (in sub-phases 1a and 2a). As noted above, there may be little or no adverse impact caused by the absence of In-BSS sounding in certain CoBF scenarios. Thus, the overhead savings achieved by not providing the In-BSS sounding each cycle may come at relatively low cost in terms of performance.

### Example Methods

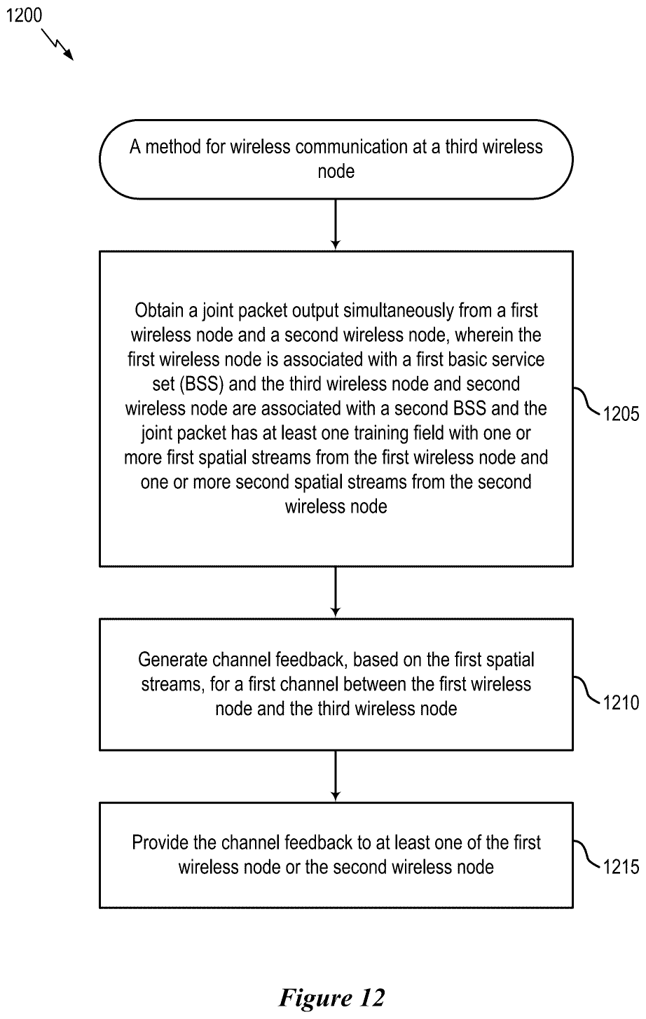

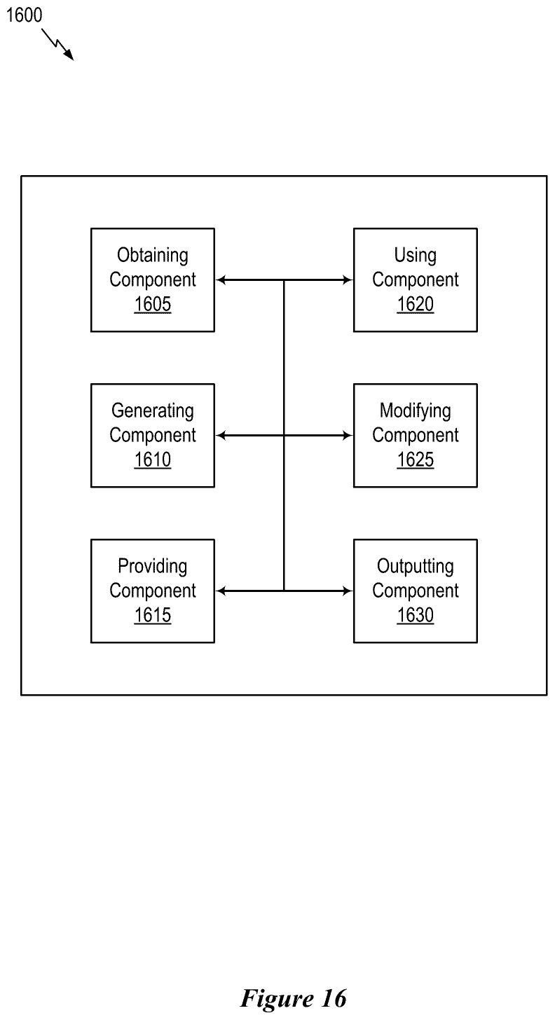

FIG. 12 shows a flowchart illustrating an example process 1200 performable by or at a third wireless node. The operations of the process 1200 may be implemented by a wireless STA, or its components as described herein, and/or wireless AP, or its components as described herein. For example, the process 1200 may be performed by a wireless communication device, such as the wireless communication device 1600 described with reference to FIG. 16, operating as or within a wireless STA or operating as or within a wireless AP. In some examples, the process 1200 may be performed by a wireless STA such as one of the STAs 104 described with reference to FIG. 1. In some examples, the process 1200 may be performed by a wireless AP such as one of the APs 102 described with reference to FIG. 1.

In some examples, in block 1205, the third wireless node may obtain a joint packet output simultaneously from a first wireless node and a second wireless node, wherein the first wireless node is associated with a first basic service set (BSS) and the third wireless node and second wireless node are associated with a second BSS and the joint packet has at least one training field with one or more first spatial streams from the first wireless node and one or more second spatial streams from the second wireless node. In some cases, the operations of this step refer to, or may be performed by, an obtaining component as described with reference to FIG. 16.

In some examples, in block 1210, the third wireless node may generate channel feedback, based on the first spatial streams, for a first channel between the first wireless node and the third wireless node. In some cases, the operations of this step refer to, or may be performed by, a generating component as described with reference to FIG. 16.

In some examples, in block 1215, the third wireless node may provide the channel feedback to at least one of the first wireless node or the second wireless node. In some cases, the operations of this step refer to, or may be performed by, a providing component as described with reference to FIG. 16.

In some aspects, the joint packet comprises a joint null data packet (NDP).

In some aspects, the process 1200 further includes obtaining information. In some cases, the operations of this step refer to, or may be performed by, an obtaining component as described with reference to FIG. 16.

In some aspects, the process 1200 further includes using the information to differentiate between the first channel and a second channel between the second wireless node and the third wireless node. In some cases, the operations of this step refer to, or may be performed by, a using component as described with reference to FIG. 16.

In some aspects, the information indicates the first spatial streams and the second spatial streams.

In some aspects, the information further indicates a quantity of at least one of the first spatial streams or the second spatial streams.

In some aspects, generating the channel feedback for the first channel based on a quantity of spatial streams the third wireless node supports for sounding being less than a total quantity of the first and second spatial streams combined.

In some aspects, the joint packet is obtained as part of a first sounding procedure; and the method further comprises generating and provide channel feedback for the second channel as part of a second sounding procedure.

In some aspects, the first sounding procedure and second sounding procedure occur at different rates.

In some aspects, the first sounding procedure occurs more frequently than the second sounding procedure.

In some aspects, the process 1200 further includes modifying the channel feedback prior to providing the channel feedback. In some cases, the operations of this step refer to, or may be performed by, a modifying component as described with reference to FIG. 16.

In some aspects, the modification is based on one or more matrices that are dependent on observations of the second channel.

Note that FIG. 12 is just one example of a process, and other processes including fewer, additional, or alternative steps are possible consistent with this disclosure.

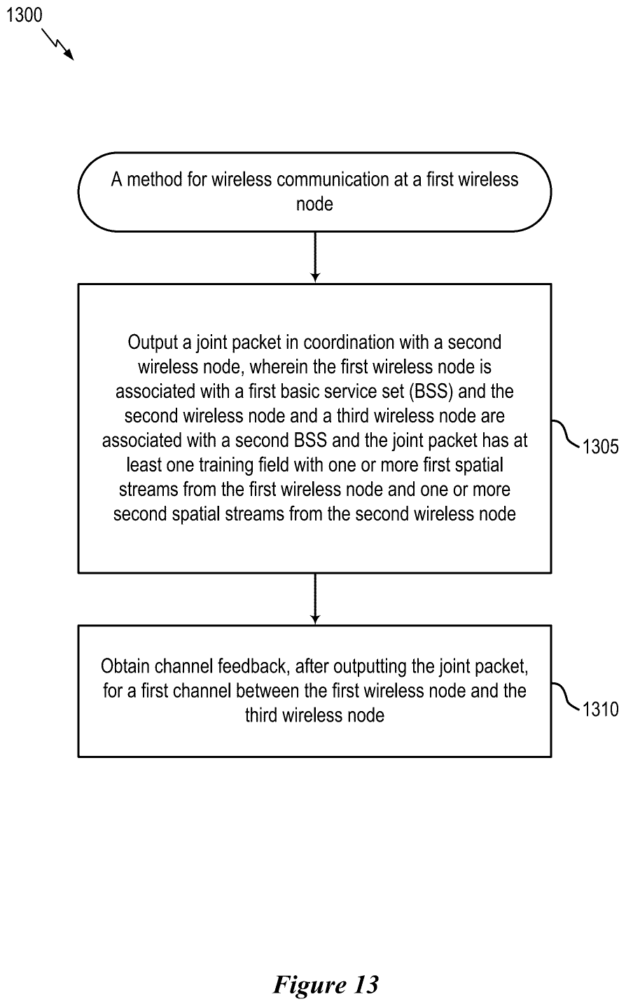

FIG. 13 shows a flowchart illustrating an example process 1300 performable by or at a first wireless node. The operations of the process 1300 may be implemented by a wireless STA, or its components as described herein, and/or wireless AP, or its components as described herein. For example, the process 1300 may be performed by a wireless communication device, such as the wireless communication device 1600 described with reference to FIG. 16, operating as or within a wireless STA or operating as or within a wireless AP. In some examples, the process 1300 may be performed by a wireless STA such as one of the STAs 104 described with reference to FIG. 1. In some examples, the process 1300 may be performed by a wireless AP such as one of the APs 102 described with reference to FIG. 1.

In some examples, in block 1305, the first wireless node may output a joint packet in coordination with a second wireless node, wherein the first wireless node is associated with a first basic service set (BSS) and the second wireless node and a third wireless node are associated with a second BSS and the joint packet has at least one training field with one or more first spatial streams from the first wireless node and one or more second spatial streams from the second wireless node. In some cases, the operations of this step refer to, or may be performed by, an outputting component as described with reference to FIG. 16.

In some examples, in block 1310, the first wireless node may obtain channel feedback, after outputting the joint packet, for a first channel between the first wireless node and the third wireless node. In some cases, the operations of this step refer to, or may be performed by, an obtaining component as described with reference to FIG. 16.

In some aspects, the joint packet comprises a joint null data packet (NDP).

In some aspects, the joint packet is output as part of a first sounding procedure; and the method further comprises a sequential packet as part of a second sounding procedure.

In some aspects, the first sounding procedure and second sounding procedure occur at different rates.

In some aspects, the first sounding procedure occurs more frequently than the second sounding procedure.

Note that FIG. 13 is just one example of a process, and other processes including fewer, additional, or alternative steps are possible consistent with this disclosure.

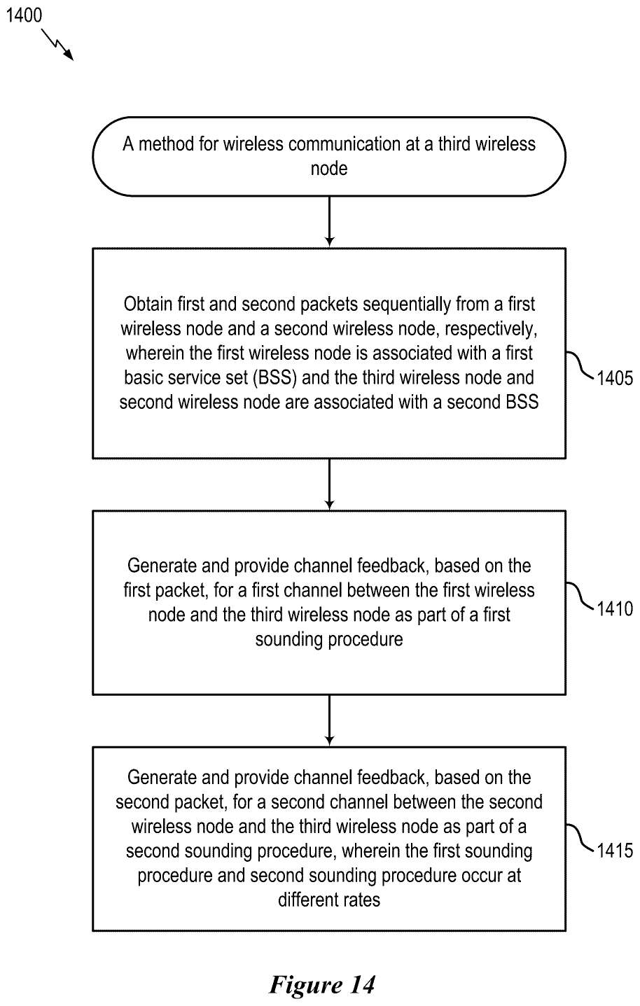

FIG. 14 shows a flowchart illustrating an example process 1400 performable by or at a third wireless node. The operations of the process 1400 may be implemented by a wireless STA, or its components as described herein, and/or wireless AP, or its components as described herein. For example, the process 1400 may be performed by a wireless communication device, such as the wireless communication device 1600 described with reference to FIG. 16, operating as or within a wireless STA or operating as or within a wireless AP. In some examples, the process 1400 may be performed by a wireless STA such as one of the STAs 104 described with reference to FIG. 1. In some examples, the process 1400 may be performed by a wireless AP such as one of the APs 102 described with reference to FIG. 1.

In some examples, in block 1405, the third wireless node may obtain first and second packets sequentially from a first wireless node and a second wireless node, respectively, wherein the first wireless node is associated with a first basic service set (BSS) and the third wireless node and second wireless node are associated with a second BSS. In some cases, the operations of this step refer to, or may be performed by, an obtaining component as described with reference to FIG. 16.

In some examples, in block 1410, the third wireless node may generate and provide channel feedback, based on the first packet, for a first channel between the first wireless node and the third wireless node as part of a first sounding procedure. In some cases, the operations of this step refer to, or may be performed by, a generating component as described with reference to FIG. 16.

In some examples, in block 1415, the third wireless node may generate and provide channel feedback, based on the second packet, for a second channel between the second wireless node and the third wireless node as part of a second sounding procedure, wherein the first sounding procedure and second sounding procedure occur at different rates. In some cases, the operations of this step refer to, or may be performed by, a generating component as described with reference to FIG. 16.

In some aspects, the first sounding procedure occurs more frequently than the second sounding procedure.

In some aspects, the first and second packets comprise null data packets (NDPs).

Note that FIG. 14 is just one example of a process, and other processes including fewer, additional, or alternative steps are possible consistent with this disclosure.

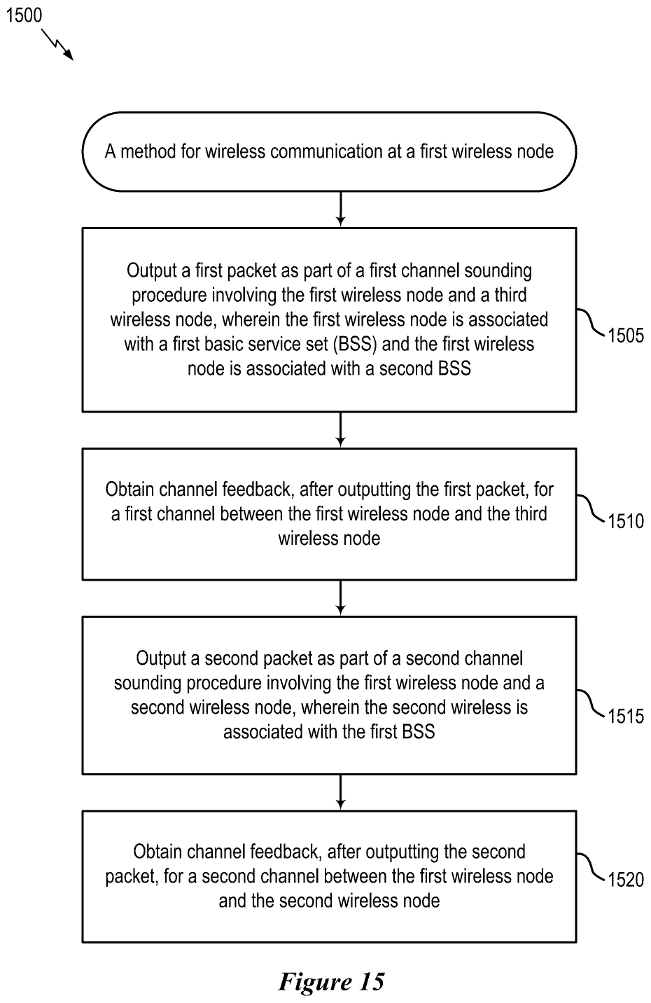

FIG. 15 shows a flowchart illustrating an example process 1500 performable by or at a first wireless node. The operations of the process 1500 may be implemented by a wireless STA, or its components as described herein, and/or wireless AP, or its components as described herein. For example, the process 1500 may be performed by a wireless communication device, such as the wireless communication device 1600 described with reference to FIG. 16, operating as or within a wireless STA or operating as or within a wireless AP. In some examples, the process 1500 may be performed by a wireless STA such as one of the STAs 104 described with reference to FIG. 1. In some examples, the process 1500 may be performed by a wireless AP such as one of the APs 102 described with reference to FIG. 1.

In some examples, in block 1505, the first wireless node may output a first packet as part of a first channel sounding procedure involving the first wireless node and a third wireless node, wherein the first wireless node is associated with a first basic service set (BSS) and the first wireless node is associated with a second BSS. In some cases, the operations of this step refer to, or may be performed by, an outputting component as described with reference to FIG. 16.

In some examples, in block 1510, the first wireless node may obtain channel feedback, after outputting the first packet, for a first channel between the first wireless node and the third wireless node. In some cases, the operations of this step refer to, or may be performed by, an obtaining component as described with reference to FIG. 16.

In some examples, in block 1515, the first wireless node may output a second packet as part of a second channel sounding procedure involving the first wireless node and a second wireless node, wherein the second wireless is associated with the first BSS. In some cases, the operations of this step refer to, or may be performed by, an outputting component as described with reference to FIG. 16.

In some examples, in block 1520, the first wireless node may obtain channel feedback, after outputting the second packet, for a second channel between the first wireless node and the second wireless node. In some cases, the operations of this step refer to, or may be performed by, an obtaining component as described with reference to FIG. 16.

In some aspects, the first sounding procedure occurs more frequently than the second sounding procedure.

In some aspects, the first and second packets comprise null data packets (NDPs).

Note that FIG. 15 is just one example of a process, and other processes including fewer, additional, or alternative steps are possible consistent with this disclosure.

### Example Device(s)

FIG. 16 shows a block diagram of an example wireless communication device 1600. In some examples, the wireless communication device 1600 is configured to perform the process 1200 described with reference to FIG. 12. In some examples, the wireless communication device 1600 is configured to perform the process 1300 described with reference to FIG. 13. In some examples, the wireless communication device 1600 is configured to perform the process 1400 described with reference to FIG. 14. In some examples, the wireless communication device 1600 is configured to perform the process 1500 described with reference to FIG. 15. The wireless communication device 1600 may include one or more chips, SoCs, chipsets, packages, components or devices that individually or collectively constitute or include a processing system. The processing system may interface with other components of the wireless communication device 1600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1600 may transmit the information output from the chip. In such an example, the second interface may refer to an interface between the processing system of the chip and a reception component, such that the device 1600 may receive information that is passed to the processing system. In some such examples, the first interface also may obtain information, such as from the transmission component, and the second interface also may output information, such as to the reception component.

The processing system of the wireless communication device 1600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1600 can be configurable or configured for use in a STA, such as the STA 104 described with reference to FIG. 1. In some other examples, the wireless communication device 1600 can be a STA that includes such a processing system and other components including multiple antennas. In some examples, the wireless communication device 1600 can be configurable or configured for use in an AP, such as the AP 102 described with reference to FIG. 1. In some other examples, the wireless communication device 1600 can be an AP that includes such a processing system and other components including multiple antennas. The wireless communication device 1600 is capable of transmitting and receiving wireless communications in the form of, for example, wireless packets. For example, the wireless communication device 1600 can be configurable or configured to transmit and receive packets in the form of physical layer PPDUs and MPDUs conforming to one or more of the IEEE 802.11 family of wireless communication protocol standards. In some other examples, the wireless communication device 1600 can be configurable or configured to transmit and receive signals and communications conforming to one or more 3GPP specifications including those for 5G NR or 6G. In some examples, the wireless communication device 1600 also includes or can be coupled with one or more application processors which may be further coupled with one or more other memories. In some examples, the wireless communication device 1600 further includes a user interface (UI) (such as a touchscreen or keypad) and a display, which may be integrated with the UI to form a touchscreen display that is coupled with the processing system. In some examples, the wireless communication device 1600 may further include one or more sensors such as, for example, one or more inertial sensors, accelerometers, temperature sensors, pressure sensors, or altitude sensors, that are coupled with the processing system. In some examples, the wireless communication device 1600 further includes at least one external network interface coupled with the processing system that enables communication with a core network or backhaul network that enables the wireless communication device 1600 to gain access to external networks including the Internet.

The wireless communication device 1600 includes obtaining component 1605, generating component 1610, providing component 1615, using component 1620, modifying component 1625, and outputting component 1630. Portions of one or more of the components 1605, 1610, 1615, 1620, 1625, and 1630 may be implemented at least in part in hardware or firmware. For example one or more of the components 1605, 1610, 1615, 1620, 1625, and 1630 may be implemented at least in part by a processor or a modem. In some examples, portions of one or more of the components 1605, 1610, 1615, 1620, 1625, and 1630 may be implemented at least in part by a processor and software in the form of processor-executable code stored in a memory.

### EXAMPLE CLAUSES

Implementation examples are described in the following numbered clauses.

Clause 1: A method for wireless communication at a third wireless node, including: obtaining a joint packet output simultaneously from a first wireless node and a second wireless node, wherein the first wireless node is associated with a first basic service set (BSS) and the third wireless node and second wireless node are associated with a second BSS and the joint packet has at least one training field with one or more first spatial streams from the first wireless node and one or more second spatial streams from the second wireless node; generating channel feedback, based on the first spatial streams, for a first channel between the first wireless node and the third wireless node; and providing the channel feedback to at least one of the first wireless node or the second wireless node.

Clause 2: The method of Clause 1, where the joint packet includes a joint null data packet (NDP).

Clause 3: The method any one of Clauses 1-2, further including: obtaining information; and using the information to differentiate between the first channel and a second channel between the second wireless node and the third wireless node.

Clause 4: The method of Clause 3, where the information indicates the first spatial streams and the second spatial streams.

Clause 5: The method of Clause 4, where the information further indicates a quantity of at least one of the first spatial streams or the second spatial streams.

Clause 6: The method any one of Clauses 1-5, further including: generating the channel feedback for the first channel based on a quantity of spatial streams the third wireless node supports for sounding being less than a total quantity of the first and second spatial streams combined.

Clause 7: The method any one of Clauses 1-6, where the joint packet is obtained as part of a first sounding procedure; and the method further includes generating and provide channel feedback for the second channel as part of a second sounding procedure.

Clause 8: The method of Clause 7, where the first sounding procedure and second sounding procedure occur at different rates.

Clause 9: The method of Clause 7, where the first sounding procedure occurs more frequently than the second sounding procedure.

Clause 10: The method any one of Clauses 1-9, further including: modifying the channel feedback prior to providing the channel feedback.

Clause 11: The method of Clause 10, where the modification is based on one or more matrices that are dependent on observations of the second channel.

Clause 12: A method for wireless communication at a first wireless node, including: outputting a joint packet in coordination with a second wireless node, wherein the first wireless node is associated with a first basic service set (BSS) and the second wireless node and a third wireless node are associated with a second BSS and the joint packet has at least one training field with one or more first spatial streams from the first wireless node and one or more second spatial streams from the second wireless node; and obtaining channel feedback, after outputting the joint packet, for a first channel between the first wireless node and the third wireless node.

Clause 13: The method of Clause 12, where the joint packet includes a joint null data packet (NDP).

Clause 14: The method any one of Clauses 12-13, where the joint packet is output as part of a first sounding procedure; and the method further includes outputting a sequential packet as part of a second sounding procedure.

Clause 15: The method of Clause 14, where the first sounding procedure and second sounding procedure occur at different rates.

Clause 16: The method of Clause 14, where the first sounding procedure occurs more frequently than the second sounding procedure.

Clause 17: A method for wireless communication at a third wireless node, including: obtaining first and second packets sequentially from a first wireless node and a second wireless node, respectively, wherein the first wireless node is associated with a first basic service set (BSS) and the third wireless node and second wireless node are associated with a second BSS; generating and provide channel feedback, based on the first packet, for a first channel between the first wireless node and the third wireless node as part of a first sounding procedure; and generating and provide channel feedback, based on the second packet, for a second channel between the second wireless node and the third wireless node as part of a second sounding procedure, wherein the first sounding procedure and second sounding procedure occur at different rates.

Clause 18: The method of Clause 17, where the first sounding procedure occurs more frequently than the second sounding procedure.

Clause 19: The method any one of Clauses 17-18, where the first and second packets include null data packets (NDPs).

Clause 20: A method for wireless communication at a first wireless node, including: outputting a first packet as part of a first channel sounding procedure involving the first wireless node and a third wireless node, wherein the first wireless node is associated with a first basic service set (BSS) and the first wireless node is associated with a second BSS; obtaining channel feedback, after outputting the first packet, for a first channel between the first wireless node and the third wireless node; outputting a second packet as part of a second channel sounding procedure involving the first wireless node and a second wireless node, wherein the second wireless is associated with the first BSS; and obtaining channel feedback, after outputting the second packet, for a second channel between the first wireless node and the second wireless node.

Clause 21: The method of Clause 20, where the first sounding procedure occurs more frequently than the second sounding procedure.

Clause 22: The method any one of Clauses 20-21, where the first and second packets include null data packets (NDPs).

Clause 23: An apparatus, including: at least one memory including executable instructions; and at least one processor configured to execute the executable instructions and cause the apparatus to perform a method in accordance with any combination of Clauses 1-22.

Clause 24: An apparatus, including means for performing a method in accordance with any combination of Clauses 1-22.

Clause 25: A non-transitory computer-readable medium including executable instructions that, when executed by at least one processor of an apparatus, cause the apparatus to perform a method in accordance with any combination of Clauses 1-22.

Clause 26: A computer program product embodied on a computer-readable storage medium including code for performing a method in accordance with any combination of Clauses 1-22.

Clause 27: A wireless node (e.g., a STA), including: at least one transceiver; at least one memory including executable instructions; and at least one processor configured to execute the executable instructions and cause the apparatus to perform a method in accordance with any combination of Clauses 1-11, wherein the at least one transceiver is configured to receive the joint packet and transmit the channel feedback.

Clause 28: A wireless node (e.g., an AP), including: at least one transceiver; at least one memory including executable instructions; and at least one processor configured to execute the executable instructions and cause the apparatus to perform a method in accordance with any combination of Clauses 12-16, wherein the at least one transceiver is configured to transmit the joint packet and receive the channel feedback.

Clause 29: A wireless node (e.g., a STA), including: at least one transceiver; at least one memory including executable instructions; and at least one processor configured to execute the executable instructions and cause the apparatus to perform a method in accordance with any combination of Clauses 17-19, wherein the at least one transceiver is configured to receive the first and second packets and transmit the channel feedback for the first channel and the channel feedback for the second channel.

Clause 30: A wireless node (e.g., an AP), including: at least one transceiver; at least one memory including executable instructions; and at least one processor configured to execute the executable instructions and cause the apparatus to perform a method in accordance with any combination of Clauses 20-22, wherein the at least one transceiver is configured to transmit the first packet and the second packet and to receive the channel feedback for the first channel and the channel feedback for the second channel.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

Means for obtaining, means for processing, means for performing, means for outputting, means for selecting, mans for using, means for pre-processing, means for generating, and means for providing may comprise one or more processors, such as one or more of the processors described above with reference to FIG. 16.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising instructions; and
one or more processors configured to execute the instructions and cause the apparatus to:
obtain a joint packet output simultaneously from a first wireless node and a second wireless node, wherein the first wireless node is associated with a first basic service set (BSS) and the apparatus and second wireless node are associated with a second BSS and the joint packet has at least one training field with one or more first spatial streams from the first wireless node and one or more second spatial streams from the second wireless node;
generate channel feedback, based on the first spatial streams, for a first channel between the first wireless node and the apparatus; and
provide the channel feedback to at least one of the first wireless node or the second wireless node.

2. The apparatus of claim 1, wherein the joint packet comprises a joint null data packet (NDP).

3. The apparatus of claim 2, wherein the one or more processors are further configured to cause the apparatus to:
obtain information; and
use the information to differentiate between the first channel and a second channel between the second wireless node and the apparatus.

4. The apparatus of claim 3, wherein:
the information indicates the first spatial streams and the second spatial streams.

5. The apparatus of claim 4, wherein the information further indicates a quantity of at least one of the first spatial streams or the second spatial streams.

6. The apparatus of claim 1, wherein the one or more processors are configured to cause the apparatus to:
generate the channel feedback for the first channel based on a quantity of spatial streams the apparatus supports for sounding being less than a total quantity of the first and second spatial streams combined.

7. The apparatus of claim 1, wherein:
the joint packet is obtained as part of a first sounding procedure; and
the one or more processors are further configured to cause the apparatus to generate and provide channel feedback for the second channel as part of a second sounding procedure.

8. The apparatus of claim 7, wherein the first sounding procedure and second sounding procedure occur at different rates.

9. The apparatus of claim 7, wherein the first sounding procedure occurs more frequently than the second sounding procedure.

10. The apparatus of claim 1, wherein the one or more processors are configured to cause the apparatus to modify the channel feedback prior to providing the channel feedback.

11. The apparatus of claim 10, wherein the modification is based on one or more matrices that are dependent on observations of the second channel.

12. The apparatus of claim 1, further comprising at least one transceiver configured to receive the joint packet and transmit the channel feedback, wherein the apparatus is configured as a wireless station.

13. An apparatus for wireless communication, comprising:
at least one memory comprising instructions; and
one or more processors configured to execute the instructions and cause the apparatus to:
output a joint packet in coordination with a second wireless node, wherein the apparatus is associated with a first basic service set (BSS) and the second wireless node and a third wireless node are associated with a second BSS and the joint packet has at least one training field with one or more first spatial streams from the apparatus and one or more second spatial streams from the second wireless node; and
obtain channel feedback, after outputting the joint packet, for a first channel between the apparatus and the third wireless node.

14. The apparatus of claim 13, wherein the joint packet comprises a joint null data packet (NDP).

15. The apparatus of claim 13, wherein:
the joint packet is output as part of a first sounding procedure; and
the one or more processors are further configured to cause the apparatus to output a sequential packet as part of a second sounding procedure.

16. The apparatus of claim 15, wherein the first sounding procedure and second sounding procedure occur at different rates.

17. The apparatus of claim 15, wherein the first sounding procedure occurs more frequently than the second sounding procedure.

18. The apparatus of claim 13, further comprising at least one transceiver configured to transmit the joint packet and receive the channel feedback, wherein the apparatus is configured as an access point.

19. An apparatus for wireless communication, comprising:
at least one memory comprising instructions; and
one or more processors configured to execute the instructions and cause the apparatus to:
obtain first and second packets sequentially from a first wireless node and a second wireless node, respectively, wherein the first wireless node is associated with a first basic service set (BSS) and the apparatus and second wireless node are associated with a second BSS;
generate and provide channel feedback, based on the first packet, for a first channel between the first wireless node and the apparatus as part of a first sounding procedure; and
generate and provide channel feedback, based on the second packet, for a second channel between the first wireless node and the apparatus as part of a second sounding procedure, wherein the first sounding procedure and second sounding procedure occur at different rates.

20. The apparatus of claim 19, wherein the first sounding procedure occurs more frequently than the second sounding procedure.

21. The apparatus of claim 19, wherein the first and second packets comprise null data packets (NDPs).

22. The apparatus of claim 19, further comprising at least one transceiver configured to receive the first and second packets and transmit the channel feedback for the first channel and the channel feedback for the second channel, wherein the apparatus is configured as a wireless station.

23. An apparatus for wireless communication, comprising:
at least one memory comprising instructions; and
one or more processors configured to execute the instructions and cause the apparatus to:
output a first packet as part of a first channel sounding procedure involving the apparatus and a first wireless node, wherein the apparatus is associated with a first basic service set (BSS) and the first wireless node is associated with a second BSS;
obtain channel feedback, after outputting the first packet, for a first channel between the apparatus and the first wireless node;
output a second packet as part of a second channel sounding procedure involving the apparatus and a second wireless node, wherein the second wireless is associated with the first BSS; and
obtain channel feedback, after outputting the second packet, for a second channel between the apparatus and the second wireless node.

24. The apparatus of claim 23, wherein the first sounding procedure occurs more frequently than the second sounding procedure.

25. The apparatus of claim 23, wherein the first and second packets comprise null data packets (NDPs).

26. The apparatus of claim 13, further comprising at least one transceiver configured to transmit the first and second packets and receive the channel feedback for the first channel and the channel feedback for the second channel, wherein the apparatus is configured as an access point.
